(19) United States
(12) Patent Application Publication
(10) Pub. No.: US 2010/0013756 A1
(43) Pub. Date: Jan. 21, 2010

(54) Electrophoretic display device and packing structure thereof

(75) Inventor: Sang-Hyun Park, Gyeongsangbuk-Do (KR)

Correspondence Address: MORGAN LEWIS & BOCKIUS LLP, 1111 PENNSYLVANIA AVENUE NW, WASHINGTON, DC, 20004, US

(73) Assignee: LG Display Co., Ltd.

(21) Appl. No.: 12/318,300

(22) Filed: Dec. 24, 2008

(30) Foreign Application Priority Data
Jul. 18, 2008 (KR) 10-2008-0070337

(51) Int. Cl. G09G 3/34

(52) U.S. Cl. 345/107

(57) ABSTRACT

An electrophoretic display device includes: an electrophoretic display panel; a COF (Chip On Film) attached to at least one side of the display panel and having a driving element mounted thereon; and a support frame installed on a rear surface of the electrophoretic display panel, wherein the COF is attached to the support frame through a double-sided tape.

The present disclosure relates to subject matter contained in priority Korean Application 10-2008-0070337, filed on Jul. 18, 2008, which is herein expressly incorporated by reference in its entirety.

### BACKGROUND OF THE INVENTION

1. Field of the Invention

The present invention relates to an electrophoretic display device and, more particularly, to an electrophoretic display device including a support frame provided on its rear surface to allow a film with a driving element mounted thereon to be attached to the support frame to thereby prevent damage of the film due to wobbling of the electrophoretic display device when the electrophoretic display device is packed and moved.

2. Description of the Related Art

In general, an electrophoretic display device is an image display device using a phenomenon that when a pair of electrodes to which voltage is applied are put in a colloidal solution, colloidal particles move to one polarity. Because the electrophoretic display device has the characteristics of a wide viewing angle, a high reflexibility, low power consumption, and the like, without employing a backlight, it receives much attention as an electronic device such as electric paper.

The electrophoretic display device has such a structure that an electronic ink layer is interposed between two substrates. One of the two substrates is a transparent substrate and the other includes a reflection plate to reflect input light to thus display an image in a reflective mode.

In general, the electrophoretic display device is fabricated in a module state by a manufacturer and then supplied to an electronic device finished product manufacturer. Then, the electronic device finished product manufacturer assembles the supplied module into an end product and provides the same to users.

FIG. 1 is a schematic view showing the related art electrophoretic display device. As shown in FIG. 1, the electrophoretic display device 10 includes a panel and a chip on film (COF) 30 attached to the panel 10 and applying a signal to the panel. Although not shown, the panel 20 includes two facing substrates, an electronic ink layer formed between the substrates and including black particles and white particles which are moved by a field formed as a signal is applied thereto to thereby implement an image, and an electrode formed on the substrates and applying various signals to the electronic ink layer. The COF 30 includes a film and a driving element mounted on the film and supplying a signal to the electrode within the panel 20.

Although not shown, an end product of the electrophoretic display device is manufactured by connecting the panel 20 and the COF 30 of the electrophoretic display device to an external host via an interface and receiving the panel 20 in a case or the like. However, the connecting of the panel 20 and the COF 30 to the host and the receiving of the panel in the case are performed mainly at the side of the electronic device finished product manufacturer, and a manufacturer of the electrophoretic display device provides the electrophoretic display device in the form of a module as shown in FIG. 1 to the finished product manufacturer.

The module type electrophoretic display device is packed, by a packing material and then provided to the finished product manufacturer by a transportation means. At this time, the related art electrophoretic display device has the following problem in transporting the module type electrophoretic display device.

The module type electrophoretic display device is packed by a packing material as shown in FIG. 2 and then transported. At this time, as shown in FIG. 2, when the panel 20 is packed by the packing material 40, there is a certain gap (t) between the panel 20 and the packing material 40. Thus, when the packed panel 29 is transported, the panel 20 moves in the packing material 40 due to the gap according to irregular wobbling, and such movement applies an impact to the panel 20, making the panel 20 defective. In particular, the COF 30 attached to the panel 20 is made of a thin film, so it is damaged due to the impact caused by the wobbling of the panel 20. In addition, the COF 30 includes the driving element mounted thereon and a metal wiring formed on its surface to connect the driving element and the electrode of the panel. The impact applied to the COF 20 causes the metal wiring to be short-circuited.

### SUMMARY OF THE INVENTION

Therefore, in order to address the above matters, the various features described herein have been conceived. One aspect of the exemplary embodiments is to provide an electrophoretic display device capable of preventing generation of a defective wiring of a COF due to an impact resulting from wobbling while a packed electrophoretic display device is transported, by attaching the COF to a rear surface of a panel, packing the electrophoretic display device, and transporting it to a finished product manufacturer.

This specification provides an electrophoretic display device including: an electrophoretic display panel; a COF (Chip On Film) attached to at least one side of the display panel and having a driving element mounted thereon; and a support frame installed on a rear surface of the electrophoretic display panel, wherein the COF is attached to the support frame through a double-sided tape.

The electrophoretic display panel may include first and second substrates; a thin film transistor (TFT) formed on the first substrate; a pixel electrode formed on the first substrate and receiving a signal via the TFT; a common electrode formed on the second substrate; and an electronic ink layer formed between the first and second substrates and including capsules including white particles and black particles which are moved according to application of a signal to thus implement an image. The support frame is formed of a mold frame. The support frame is installed along at least one side of the electrophoretic display panel and combined by a screw or a double-sided tape.

The present invention in which the COF, which is generally attached to a panel, is attached to a rear surface of the panel, has the following advantages.

That is, first, after the COF is attached to the rear surface of the panel, the electrophoretic display device is packed and transported to a finished product manufacturer, whereby generation of a defective wiring of the COF due to an impact resulting from wobbling while the packed electrophoretic display device is being transported can be prevented.

Second, upon receiving the electrophoretic display device with the COF attached to the rear surface of the panel, the finished product manufacturer does not need to perform a process of combining the COF to the rear surface of the panel to a frame, so the electrophoretic display device can be quickly assembled.

Third, because the COF is attached by the mold frame without the necessity of any extra frame, so the weight and the thickness of the electrophoretic display device can be reduced.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view showing the related art electrophoretic display device;

FIG. 2 is a view showing the related art electrophoretic display device as packed;

FIG. 3 is a view showing an electrophoretic display device according to an embodiment of the present invention;

FIG. 4 is a sectional view showing a panel structure of the electrophoretic display device according to an embodiment of the present invention;

FIG. 5a is a schematic plan view showing a COF attached to a support frame in the electrophoretic display device according to an embodiment of the present invention;

FIG. 5b is a schematic sectional view showing the COF attached to the support frame in the electrophoretic display device according to an embodiment of the present invention;

FIG. 6 is a view showing the electrophoretic display device as packed according to an embodiment of the present invention; and

FIGS. 7a and 7b show assembling of the related art electrophoretic display device in a finished product manufacturer.

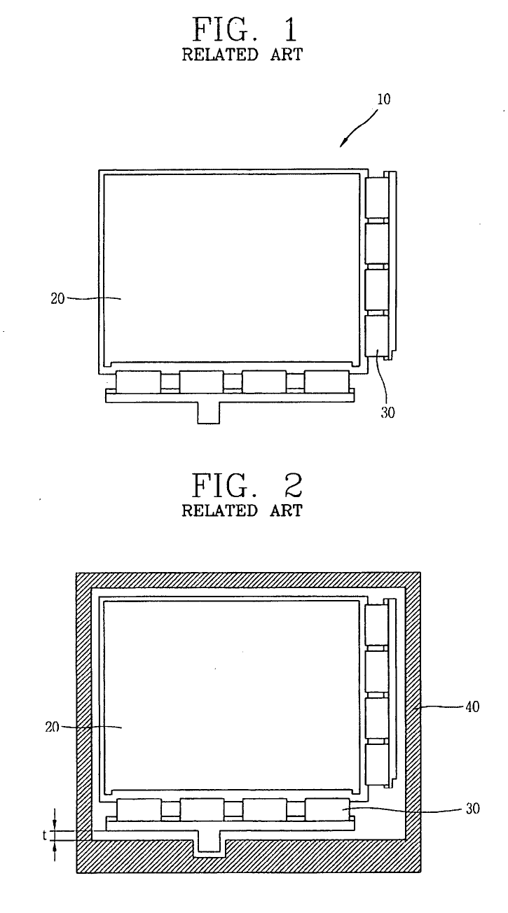

### DETAILED DESCRIPTION OF THE INVENTION

An electrophoretic display device according to the present invention will now be described with reference to the accompanying drawings.

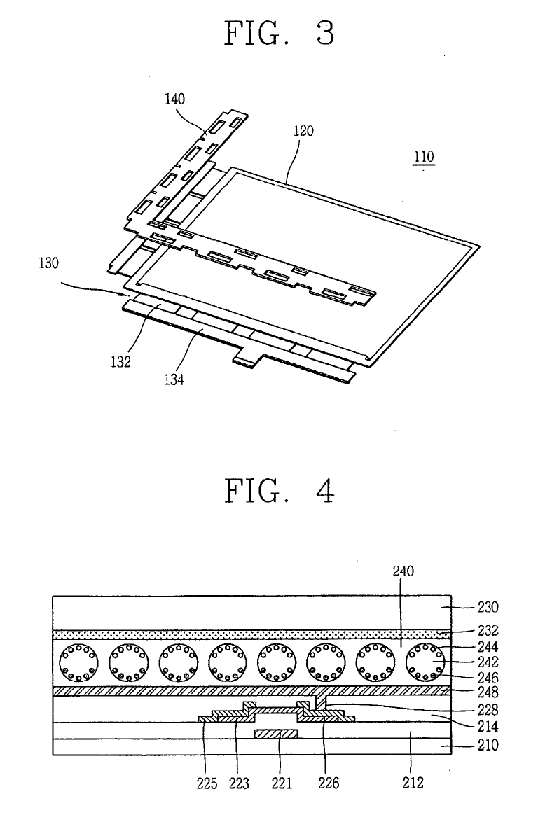

FIG. 3 is a view showing an electrophoretic display device according to an embodiment of the present invention.

As shown in FIG. 3, the electrophoretic display device 110 according to the present invention includes a panel 120 including electronic ink having white particles and black particles moving according to an application of a signal to implement an actual image, a COF 130 attached to the panel 120, having a driving element or the like thereon, and applying a signal to the panel 120, and a support frame 140 installed to the rear surface of the panel 120 and having the COF 130, which is folded toward the rear surface of the panel 120, attached thereto.

The COF 130 includes a film 132 and a printed circuit board (PCB) 134. The film 132, a TCP (Taped Carrier Package), includes a thin film transistor (TFT), driving circuits applying a signal to a pixel electrode, and various wirings formed thereon. Various electronic components such as a controller, a DC/DC converting unit, a power supply unit are mounted on the PCB 134.

The support frame 140 is a mold frame, which is attached to the rear surface of the panel 120, and the COF 130 is attached to the support frame 140. The support frame 140 is formed only at the portion of the panel 120 where the COF 130 is to be formed, not on the entire region of the rear surface of the panel 120, so that the COF 130 is attached thereto.

In general, the COF 130 is attached to the panel 120 along one side or both sides of the panel 120, so the support frame 140 is installed along one side or both sides of the panel 120 on the rear surface of the panel 120.

The electrophoretic display device 110 implements an image by reflecting light made incident by white particles and black particles of the electronic ink, without the necessity of a backlight such as for the liquid crystal display (LCD) and thus minimizing power consumption. The detailed structure of the panel 120 of the electrophoretic display device is shown in FIG. 4. Substantially the electrophoretic display device 110 includes a plurality of pixels defined by a plurality of gate lines and data lines arranged on a substrate, but only a single pixel is shown in FIG. 4.

As shown in FIG. 4, the electrophoretic display panel 120 includes a first substrate 210, a second substrate 230, a TFT and a pixel electrode 228 formed on the first substrate 210, a common electrode 232 formed on the second substrate 230, and an electronic ink layer 240 formed between the first and second substrates 210 and 230.

The TFT includes a gate electrode 221 formed on the first substrate 210, a gate insulating layer 212 formed on the entire region of the first substrate 210 with the gate electrode 221 formed thereon, a semiconductor layer 223 formed on the gate insulating layer 212, and a source electrode 225 and a drain electrode 226 formed on the semiconductor layer 223. A passivation layer 214 is formed on the TFT, namely, on the source electrode 225 and the drain electrode 226.

The electronic ink layer 240 is formed by distributing capsules 242 formed by filling an electronic ink in a polymer binder. The electronic ink distributed in the capsules 242 include white particles (or white ink 244) and black particles (or black ink 246). The white particles 244 and the black particles 246 have the characteristics of positive charges and negative charges, respectively. Namely, the white particles 244 are charged with positive charges, and the black particles 246 are charged with negative charges.

A pixel electrode 228 is formed at the passivation layer 214 of the first substrate 210 to apply a signal to the electronic ink layer 240. A contact hole is formed at the passivation layer 214 so that the pixel electrode 228 at the upper portion of the passivation layer 214 is connected with the drain electrode 226 of the TFT via the contact hole.

The common electrode 232 is formed on the second substrate 230. The common electrode 232, facing the pixel electrode 228, forms an electric field at the electronic ink layer 240 together with the pixel electrode 228 when a signal is applied to the pixel electrode 228, and the white particles 244 and the black particles 246 are moved by the electric field to implement an image.

In the thusly configured electrophoretic display device, when a signal is inputted from the exterior and applied to the pixel electrode 228 via the TFT formed on the first substrate 210, the white particles 244 and the black particles 246 are separated in the capsules 242 by the electric field generated between the pixel electrode 228 and the common electrode 232. For example, when a negative (−) voltage is applied to the pixel electrode 228, the common electrode 232 of the second substrate 230 has a positive (+) potential relatively, so the white particles 244 assuming the positive (+) charges are moved toward the first substrate 210, while the black particles 246 assuming the negative (−) charges are moved toward the second substrate 230. In this state, when light is inputted from the exterior, namely, from an upper side of the second substrate 230, the inputted light is reflected by the black particles 246 to implement black on the electrophoretic display device.

Conversely, when the positive (+) voltage is applied to the pixel electrode 228, the common electrode 232 of the second substrate 230 has the negative (−) potential, so the white particles 244 assuming the positive (+) charges are moved to the second substrate 230 while the black particles 246 assuming the negative (−) charges are moved to the first substrate 210. In this case, the polarities of the white particles 244 and the black particles 246 may be interchanged.

In this state, when light is inputted from the exterior, namely, from the upper side of the second substrate 230, the inputted light is reflected by the white particles 244, so white is implemented on the electrophoretic display device.

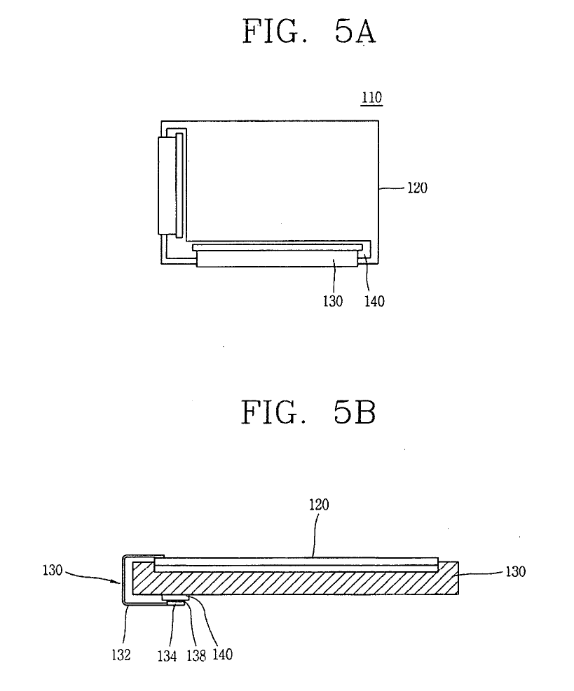

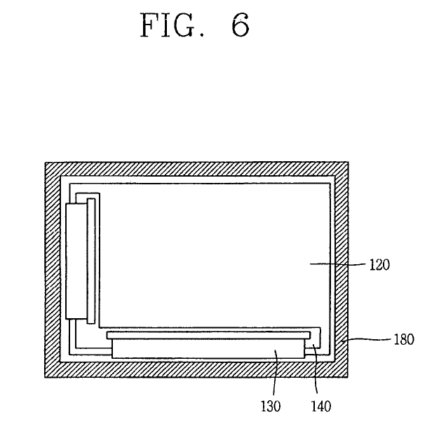

FIG. 5a is a schematic plan view showing a COF attached to a support frame in the electrophoretic display device according to an embodiment of the present invention, and FIG. 5b is a schematic sectional view showing the COF attached to the support frame in the electrophoretic display device according to an embodiment of the present invention.

As shown in FIGS. 5a and 5b, the panel 120 is supported by a main support 160, and the support frame 140 is attached to the rear surface of the main support 160. Although not shown, the support frame 140 may be attached to the rear surface of the main support 160 by a screw or by a double-sided tape.

The COF 130 is attached to the support frame 140. In this case, the film 132 of the COF 130 is attached to the support frame 140 of the rear surface of the main support 160 in a state of being bent (folded) toward the rear side from the front side of the main support 160. The COF 130 is attached by a double-sided tape 138, and only the PCB frame 134 of the COF 130 is attached to the support frame 140 or the PCB 134 and a portion of the film 132 of the COF 130 are attached to the support frame 140.

The COF 130 is attached in a module state to the rear surface of the main support 160. Namely, electrophoretic display device manufacturer installs the support frame 140 on the rear surface of the main support 160, attaches the COF 130 to the support frame 140, and provides the electrophoretic display device in this state to the finished product manufacturer. Accordingly, when the electrophoretic display device manufacturer provides the manufactured electrophoretic display device to the finished product manufacturer, it packs the electrophoretic display device 110 by a packing material such that the COF 130 is attached to the rear frame 140 of the rear surface of the main support 160.

FIG. 6 shows the packed electrophoretic display device 110. As shown in FIG. 6, the electrophoretic display device 110 is separated with a certain interval from the packing material 180, so when the electrophoretic display device 110 is transported, the electrophoretic display device 110 would be moved within the packing material 180 due to irregular wobbling, receiving an impact applied thereto. However, in the present invention, because the COF 130 is attached to the rear surface of the main support 160, the impact applied to the electrophoretic display device 110 is not directly applied to the COF 130. Thus, the film 132 of the COF 130 is not damaged, and accordingly, a problem such as disconnection of the wirings formed on the film 132 does not arise.

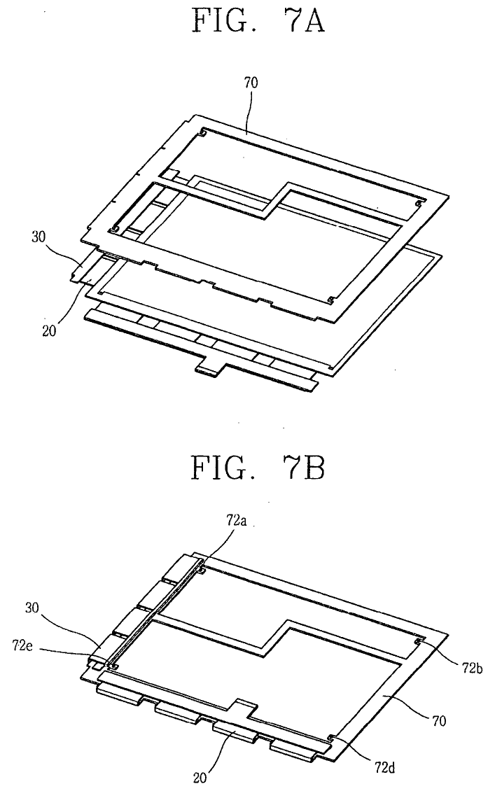

Comparatively, the related art electrophoretic display device is packed with the COF not attached to the rear surface of the main support and provided to the finished product manufacturer. Then, the finished product manufacturer directly assembles the electrophoretic display device such that the COF is attached to the rear surface of the main support. Namely, as shown in FIGS. 7a and 7b, the finished product manufacturer folds the COF 30 of the provided electrophoretic display device 20 to allow the COF 30 to contact with the rear surface of the main support, and then, couples a sub-frame 70 to the main support to thereby fix the COF 30. At this time, the sub-frame 70 is fixed by a plurality of screws 72a to 72d.

The case where the COF 130 is attached to the rear surface of the main support 160 and then provided to the finished product manufacturer likewise as in the present invention and the case where the COF 30 is provided to the finished product manufacturer in a state that it is not attached to the rear surface of the main support will be compared as follows.

First, when the COF 130 is attached to the rear surface of the main support 160 and the provided to the finished product manufacturer, an assembling time of the electrophoretic display device in the finished product manufacturer can be reduced compared with the case where the COF 30 is provided to the finished product manufacturer in a state that it is not attached to the rear surface of the main support. Namely, in the related art, the finished product manufacturer directly bends the COF of the electrophoretic display device and contacts it to the rear surface of the panel, and in this state, the finished product manufacturer couples the sub-frame 70 to the main support by a screw to thus couple the electrophoretic display device. In comparison, in the present invention, because the electrophoretic display device is provided in a state that the COF 130 is attached to the rear surface of the main support 160 to the finished product manufacturer. Thus, the finished product manufacturer does not need to assemble the sub-frame as it does in the related art, and thus, the assembling time can be considerably reduced.

Second, when the COF 130 is attached to the rear surface of the main support 160 and the provided to the finished product manufacturer, the weight of the electrophoretic display device in the finished product manufacturer can be reduced compared with the case where the COF 30 is provided to the finished product manufacturer in a state that it is not attached to the rear surface of the main support. The sub-frame used in the related art electrophoretic display device is made of stainless steel, while the support frame of the electrophoretic display device according to the present invention is a mold frame, so the weight of the electrophoretic display device can be considerably reduced compared with the related art electrophoretic display device. In addition, the size of the sub-frame of the related art electrophoretic display device is similar that of the panel, while in the present invention, the support frame of the electrophoretic display device is formed along one side or two sides of the main frame, so the weight can be further reduced. In addition, unlike the related art electrophoretic display device, the present invention does not need a screw for screw fastening, so the weight can be further reduced.

Third, when the COF 130 is attached to the rear surface of the main support 160 and the provided to the finished product manufacturer, the thickness of the electrophoretic display device in the finished product manufacturer can be reduced compared with the case where the COF 30 is provided to the finished product manufacturer in a state that it is not attached to the rear surface of the main support. As described above, in the related art electrophoretic display device, the sub-frame made of the stainless steel is coupled to the main support, while in the present invention, the support frame formed as the mold frame is attached to the main support, so the thickness of the electrophoretic display device can be reduced.

Thus, because the electrophoretic display device is provided in the state that the COF 130 is attached to the rear surface of the main support 160 to the finished product manufacturer, damage of the COF 130 of the packed electrophoretic display device can be prevented, the weight and thickness of the electrophoretic display device can be also reduced, and the assembling time of the electrophoretic display device in the finished product manufacturer can be also advantageously reduced.

The particular structure of the electrophoretic display device has been described, but the present invention is not limited to such structure. For example, the present invention can be applicable to an electrophoretic display device implementing color by including color filters, an electrophoretic display device having a reflector, or the like. In other words, the present invention can be applicable to electrophoretic display devices of any known structures as well as to the electrophoretic display device having the particular structure and size.

As the present invention may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. An electrophoretic display device comprising:
an electrophoretic display panel;
a COF (Chip On Film) attached to at least one side of the display panel and having a driving element mounted thereon; and
a support frame installed on a rear surface of the electrophoretic display panel,
wherein the COF is attached to the support frame through a double-sided tape.

2. The device of claim 1, wherein the electrophoretic display panel comprises:
first and second substrates;
a thin film transistor (TFT) formed on the first substrate;
a pixel electrode formed on the first substrate and receiving a signal via the TFT; a common electrode formed on the second substrate; and
an electronic ink layer formed between the first and second substrates and including capsules including white particles and black particles which are moved according to application of a signal to thus implement an image.

3. The device of claim 1, wherein the support frame is a mold frame.

4. The device of claim 3, wherein the electrophoretic display panel is supported by a main support, and the support frame is installed on a rear surface of the main support.

5. The device of claim 1, wherein the support frame is installed along at least one side of the electrophoretic display panel.

6. The device of claim 1, wherein the support frame is coupled to the rear surface of the electrophoretic display panel by a screw or a double-sided tape.

7. The device of claim 1, wherein the COF comprises:
a TCP (Taped Carrier Package) with a driving element and wirings formed thereon; and
a PCB (Printed Circuit Board) with electronic components mounted thereon

8. A packing structure of an electrophoretic display device, comprising:
an electrophoretic display device comprising an electrophoretic display panel, a COF (Chip On Film) attached to at least one side of the display panel and having a driving element mounted thereon, and a support frame installed on a rear surface of the electrophoretic display panel; and
a packing material for packing the electrophoretic display device,
wherein the COF of the electrophoretic display device is attached to the support frame by a double-sided tape to prevent an impact from being applied to the COF due to wobbling of the electrophoretic display device packed by the packing material.
